(19) United States
(12) Patent Application Publication
(10) Pub. No.: US 2012/0021268 A1
(43) Pub. Date: Jan. 26, 2012

(54) BIPOLAR BATTERY WITH IMPROVED OPERATION

(75) Inventors: Sophie Mailley, Le Pin (FR); Pascal Tiquet, Grenoble (FR)

(73) Assignee: Commissariat A L'Energie Atomique et Aux Ene Alt, Paris (FR)

(21) Appl. No.: 13/259,947

(22) PCT Filed: Mar. 24, 2010
(86) PCT No.: PCT/EP10/53838

§ 371 Date: Sep. 23, 2011

(30) Foreign Application Priority Data
Mar. 26, 2009 (FR) 09 01422

(51) Int. Cl. H01M 10/0525; H01M 10/36

(52) U.S. Cl. 429/94; 429/210

(57) ABSTRACT

A bipolar battery including unit cells fitted with an element including a first electronic conductive support, a second electronic conductive support, an electronic conductive connection connecting the first and the second support, with each support including a first and a second face separate from the first and second faces of the other support, a positive electrode material deposited on one of the faces of the first conductor, and a negative electrode material deposited on one of the faces of the other support. The positive electrode material is supported by the first support, and is positioned facing a negative electrode material, the negative electrode material is supported by the second support, and is positioned opposite a positive electrode material, where the facing electrode materials are separated by an insulator containing an electrolyte, thus forming two juxtaposed unit cells.

### TECHNICAL FIELD AND PRIOR ART

The present invention relates to a bipolar battery with improved operation.

Batteries such as, for example, lithium accumulators, operate on the principle of insertion and removal (or insertion and de-intercalation) of lithium on at least one electrode.

There are several types of architecture for these batteries.

One of the types of architecture is unipolar architecture. A positive electrode material is deposited on a first collector, and a negative electrode material is deposited on a second collector. The two collectors are superimposed such that the positive and negative electrodes are facing one another, and a ceramic or composite polymer separator is inserted between the two electrodes. To increase the electrode surface and the capacity of the element the collector can be coated on both faces.

This stack can be rolled so as to have a cylindrical geometry, as is described in document US 2006/0121348.

Several of these stacks can be superimposed, as is described in document US2008/0060189. The stacks are connected in parallel.

This type of architecture offers a large active surface of material, and therefore a high generated current density. However, the difference of potential at the terminals of these architectures is limited to that between the two electrode materials.

In order to increase the voltage at the batteries' terminals another architecture has been proposed. This consists of producing bipolar collectors having on one face a positive electrode and on another face a negative electrode; the collectors produced in this fashion are superimposed, and separators are positioned between the electrodes. The stack then forms multiple electrochemical cells connected in series. The voltage at the battery's terminals is equal to the sum of the voltages at the terminals of each of the cells. Consequently, this architecture enables a bipolar battery to be provided with a high voltage at its terminals. This type of architecture is described, for example, in document WO 2006/061696.

However, in order to ensure satisfactory operation of each of the cells there must be satisfactory contact of the electrolyte with the positive and negative electrodes and the separator, and this contact defines the active surface. In addition, each of the cells must be sealed. To do so, a compression effort is applied to the stack. This compression effort is applied to the collectors at the ends of the stack. However, this effort is never constant over time since it is dependent on the creep of the sealing joints. In addition, it is complex to achieve the application of a uniform effort to each of the cells of the stack. There is a risk that the different cells will have varying operation. Indeed, each of the cells generates a counter-pressure on the adjacent cells. Some cells can then reach the potential limits more or less rapidly; the battery is then charged in an incomplete fashion.

In addition, this stack structure does not always allow integration which is appropriate for the application.

It is, consequently, one aim of the present invention to provide a bipolar battery having a high voltage at its terminals and a uniform operation of its various cells and, more generally, to provide a battery the operation of which is improved, and with greater reliability.

### ACCOUNT OF THE INVENTION

The aim set out above is attained by a structure formed by the juxtaposition of unit cells connected in series, the structure being obtained by the use of elements each of which is formed of a negative electrode and a positive electrode supported by an electronic collector, and where the positive and negative electrodes of a given collector are staggered such that, when the unit cells are produced by the assembly of the elements, the adjacent unit cells are not stacked. Thus, a pressure can then be applied to the electrodes of each of the cells, independently of the other cells, and each cell is not subject to the backward force applied by the adjacent cells. It is then possible to have roughly balanced properties of all the cells. In addition, production of the seals is simplified.

In other words, the structure of the battery is developed such that the back pressure exerted by a cell is not applied to the adjacent cell. The unit cells are juxtaposed instead of being produced by stacking.

In addition, by virtue of the invention, it is possible to produce batteries the shape of which can be adapted to the application. Indeed, it is possible to use collectors having a certain flexibility, enabling the cells to be oriented relative to one another with great freedom.

The subject-matter of the present invention is thus mainly an element for a bipolar battery intended for the production of two unit cells having a first electronic conductive support, a second electronic conductive support, and an electronic conductive connection connecting the first and the second supports, where each support has a first and a second face distinct from the first and second faces of the other support, and where the said element also comprises a positive electrode material deposited on one of the faces of the first conductor and a negative electrode material deposited on one of the faces of the other support.

In an advantageous embodiment the faces on which the positive electrode material and the negative electrode material are deposited are opposite relative to the general surface formed by the supports.

The first support and the second support are advantageously positioned in two parallel planes.

The first support, the second support and the connection can be produced as a single piece from a plate.

In an advantageous example the plate is thin, so as to allow easy shaping.

The first support and the second support are, for example, made of nickel, copper, aluminium or aluminium alloy.

The bipolar battery element according to the present invention can be formed by a sealed carbon fabric on which a metal film, for example nickel, copper or aluminium, is deposited on one of the faces of the fabric.

The positive electrode material is, for example, LiFePO4 blended with a polymer binder of the PVDF type, and the negative electrode material is Li4Ti5O12 blended with a polymer binder of the PVDF type.

The bipolar battery element according to the present invention can comprise, in the area of the connection, through channels, for example via holes, when produced by injection.

Another subject-matter of the present invention is a bipolar battery comprising at least one element according to the present invention; the positive electrode material supported by the first support is positioned facing a negative electrode material, the negative electrode material supported by the second support is positioned facing a positive electrode material, where the facing electrode materials are separated by an insulator containing an electrolyte, thus forming two juxtaposed unit cells.

The bipolar battery can comprise at least a first element and a second element according to the present invention, where the positive electrode material of the first element is positioned facing a negative electrode material of the second element, the negative electrode material of the first element is positioned facing a positive electrode material, and the positive electrode material of the second element is positioned facing a negative electrode material, and where an insulator containing an electrolyte is positioned between the pairs of facing electrode materials, so as to form three juxtaposed unit cells.

An electrical insulated joint may be interposed between the facing supports so as to seal the unit cells, and an electrically insulating film covers the free faces of the supports; the insulated joint is made, for example, from elastomer, latex or thermoplastic rubber.

The bipolar battery according to the present invention may comprise an additional film thickness in the area of the electronic connections between the support of a given element.

The bipolar battery according to the present invention may also comprise means able to apply a compression effort to each unit cell in order to apply, one against the other, the positive electrode materials, the negative electrode materials and the insulator of each unit cell.

These means may be formed by an tight jacket in which the unit cells are introduced, where the jacket is pumped down to a vacuum, such that compression efforts are applied to the unit cells.

Tightness of the unit cells may be obtained by injection of a joint, made for example of thermoplastic polymer, and the compression of each of the cells is obtained by coating with a thermoplastic material, for example by injection. In these cases the elements have through channels, of the via hole type, in the area of the connection between the supports.

In an example embodiment, the unit cells are arranged in a rectilinear strip. For example, part of the strip is wound around a conductive spindle and another part of the strip is wound around another conductive spindle, with an electrical insulating film being inserted in the windings, and with the voltage at the terminals of the battery being the voltage between the two conductive spindles. In another example, both adjacent unit cells are folded back one towards the other so as to be stacked, with an electrically insulating film being positioned between the adjacent unit cells.

Adjacent unit cells may be oriented in different directions.

The unit cells may also be oriented so as to form a three-dimensional structure.

The battery according to the present invention can comprise, connected in parallel, at least two unit cell assemblies connected in series.

### BRIEF DESCRIPTION OF THE ILLUSTRATIONS

The present invention will be better understood using the description which follows and the appended illustrations, in which:

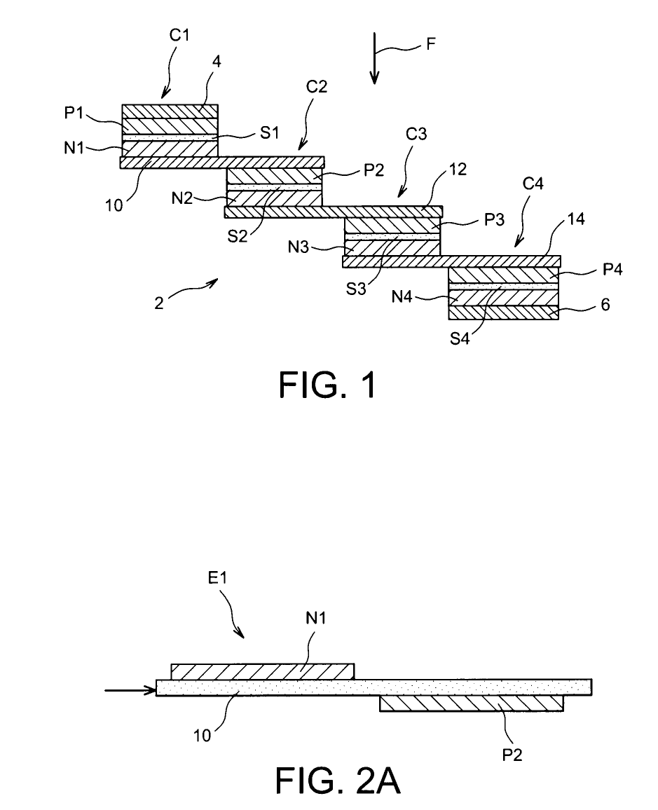

FIG. 1 is a schematic representation of an example implementation of a bipolar battery according to the present invention,

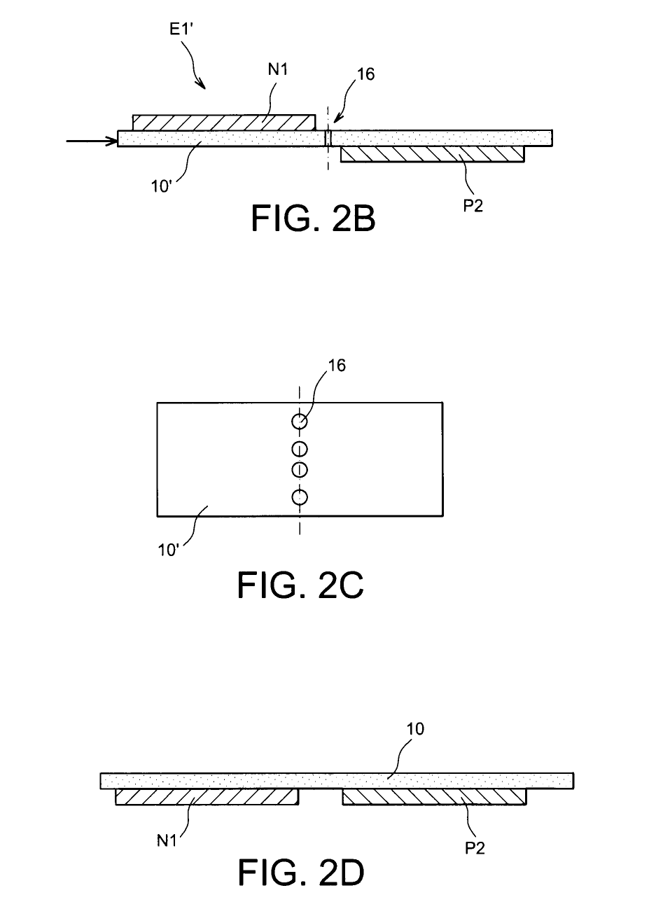

FIG. 2A is a representation of a unit element of the battery of FIG. 1,

FIG. 2B is a variant embodiment of the element of FIG. 2A,

FIG. 2C is a top view of a detail of FIG. 2B,

FIG. 2D is a variant of the embodiment of the element of FIG. 2A in which the positive and negative electrodes are produced on the same collector face,

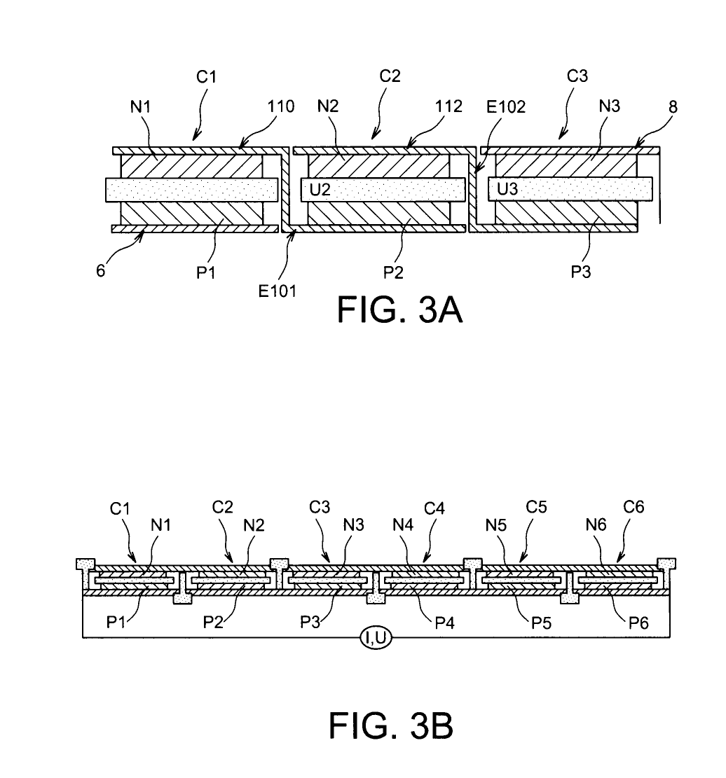

FIG. 3A is a schematic representation of another example embodiment of a bipolar battery according to the present invention using unit elements distributed over both faces of the electronic collector,

FIG. 3B is a schematic representation of another example embodiment of a bipolar battery using unit elements distributed over one electronic collector face,

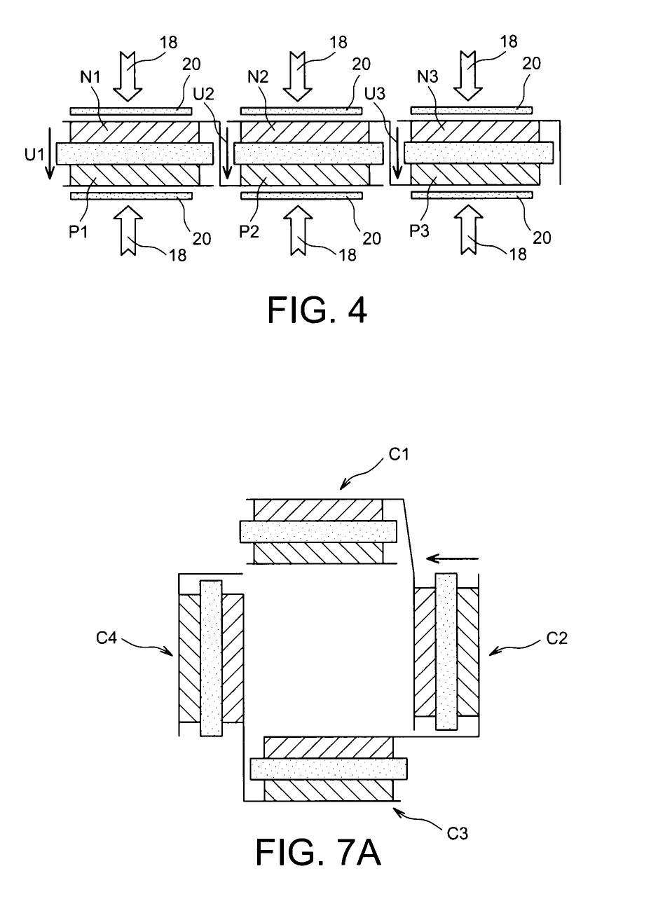

FIG. 4 is a representation of the battery of FIG. 3A fitted with means to apply pressure to each of the cells,

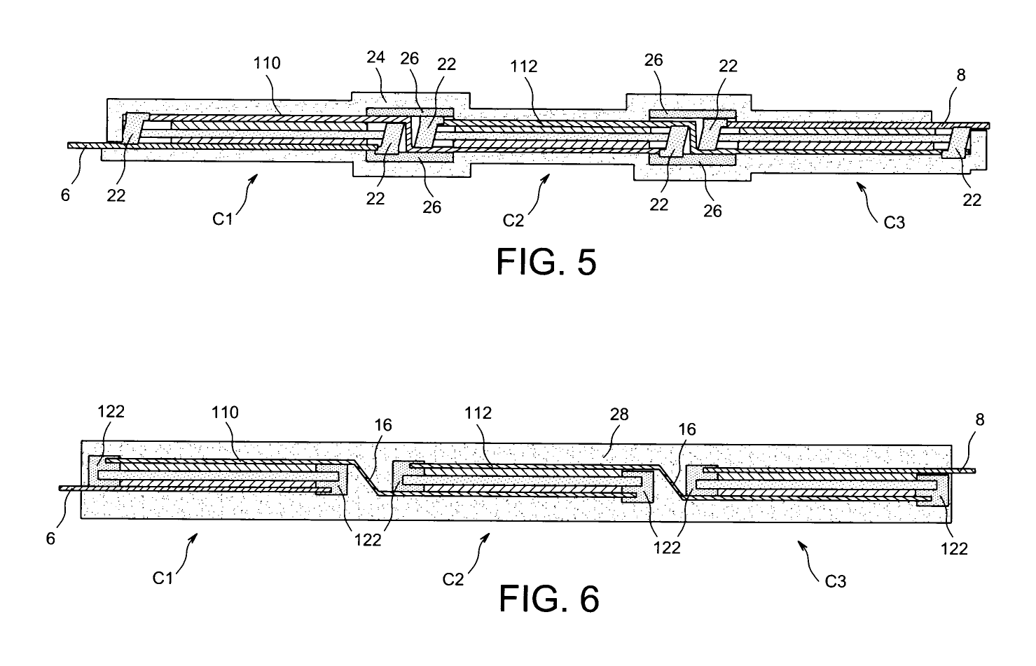

FIG. 5 is a representation of the battery of FIG. 3 produced with a first type of sealing,

FIG. 6 is a representation of the battery of FIG. 3 produced with a second type of sealing,

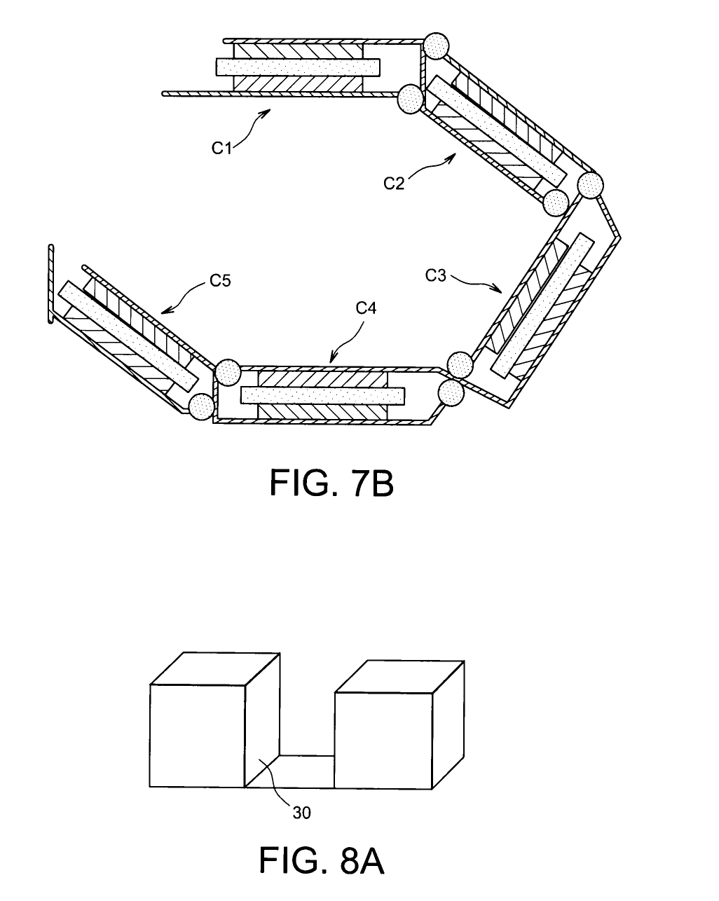

FIGS. 7A, 7B, 8A, 8B, 9A, 9B, 10A, 10B, 11A to 11D and 12 are schematic representations of various configurations which a battery according to the present invention may take.

### DETAILED ACCOUNT OF PARTICULAR EMBODIMENTS

In FIG. 1 a first example embodiment of a bipolar battery according to the present invention can be seen, and in FIG. 2A an insulated element of this battery can be seen.

In the present application we shall designate as a bipolar electrode an electronic conductive support having two faces, where one of the faces is covered with a positive active layer and where the other face is covered with a negative active layer, so as to form respectively a positive electrode and a negative electrode.

We shall also designate as a “unit cell” the assembly formed by a positive electrode supported by a current collector, an electrolytic separator, and a negative electrode supported by another current collector.

The same references will be used throughout the description to designate elements having similar structure and function.

In FIG. 1 battery 2 is formed by four unit cells C1 to C4 connected in series.

We shall designate the positive electrodes by P and the negative electrodes by N, followed by an index indicating the cell to which they belong. The separators will be designated by S.

Unit cell C1 has a positive electrode P1, a negative electrode N1, and a separator S1, interposed between electrodes P1 and N1.

Unit cell C2 has a positive electrode P2, a negative electrode N2, and a separator S2, interposed between electrodes P2 and N2.

Unit cell C3 has a positive electrode P3, a negative electrode N3, and a separator S3, interposed between electrodes P3 and N3.

Unit cell C4 has a positive electrode P4, a negative electrode N4, and a separator S4, interposed between electrodes P4 and N4.

Positive electrode P1 is deposited on a unipolar current collector 4 intended to be connected to a terminal of a device (not represented) which the battery powers. Negative electrode N4 is deposited on a unipolar current collector 6 intended to be connected to the other terminal of the device which the battery powers.

Negative electrode N1 of cell C1 and positive electrode P2 of cell C2 are each supported on a face of an electronic conductor 10.

Negative electrode N2 of cell C2 and positive electrode P3 of cell C3 are each supported on a face of an electronic conductor 12.

Negative electrode N3 of cell C3 and positive electrode P4 of cell C4 are each supported on a face of an electronic conductor 14.

According to the present invention, positive electrodes P2, P3, P4 and negative electrodes N1, N2, N3 are positioned respectively on electronic conductors 10, 12, 14 in staggered fashion such that they are not positioned one above the other, i.e. looking in the direction of arrow F, the positive electrode of a cell and the negative electrode of the adjacent cell supported by the same electronic conductor do not cover one another.

The result is that two adjacent unit cells are not stacked but juxtaposed. In the represented example the battery has the shape of a staircase.

In FIG. 2A a bipolar electrode E1 formed by electronic conductor 10 and electrodes N1 and P2 can be seen.

In FIGS. 2B and 2C, a variant of a bipolar electrode E1′ can be seen; it is distinguished by the fact that the electronic conductor 10′ has channels 16 connecting both faces in a zone located between the two electrodes N1, P2 in order to facilitate production of the architecture of the battery by injection of thermoplastic material, as we shall see in the remainder of the description. The channels are of the via hole type.

In FIG. 2D electrodes N1 and P2 are on the same electronic conductor face.

In FIG. 3A another example of an embodiment of a battery according to the present invention can be seen, which has the advantage that it has a roughly flat structure.

To accomplish this, electronic conductors 110, 112 have been shaped so as to form a step. Each electronic conductor has a first zone positioned in a first plane, a second zone positioned in a second plane which is roughly parallel to the first plane, and a third zone connecting the first and second zones.

Each bipolar electrode E101, E102 has an electrode N1 in the first zone and an electrode P2 in the second zone.

Bipolar electrodes E101, E102 are fitted into one other.

The staggering between the face receiving the positive electrode material and the face receiving the negative electrode material is such that it enables a flat structure to be produced. The height of the staggering between the two faces of the conductor supporting the electrode materials is roughly equal to the thickness of the stack of a positive electrode material, a negative electrode material and the separator. As an example, a bipolar plate forming an electronic conductor having a thickness of 20 to 250 μm, a separator having a thickness of 20 μm to 150 μm, and electrodes having thicknesses of 30 μm to 300 μm, and more particularly of 80 μm to 150 μm, and a staggering with a height of 80 μm and 750 μm can be chosen. if the height of the step formed by the conductor is considered, the thickness of the conductor is taken into account, the latter being, for example, between 01 mm and 1 mm.

Flexibility of the sealed inter-cell bipolar junction can be obtained by using a thin electronic conductor, for example between 20 and 250 μm thick, preferably between 20 μm and 100 μm thick, and preferably made in metal.

Advantageously, the electronic conductors are produced from a single part and formed by folding or drawing.

Electronic conductors 10, 12, 14 and 110, 114 can be made, for example, from nickel, copper, aluminium or aluminium alloy, the choice of material being made according to the compatibility with the materials constituting electrodes N and P. It is also possible to envisage using a carbon composite formed from an tight carbon composite on which, in order to ensure the electrochemical and chemical compatibility with the electrode material, a metal film (of nickel, copper or aluminium) is deposited on one of the faces by a vacuum deposit process, of the CVD or PVD type, or electroplating or electroless deposit, in order to produce electronic conduction.

FIG. 3B shows the case in which the configuration of the conductors of FIG. 2D is used. It is not necessary to fold the conductor between the two cells. This approach thus enables electronic conductors of greater thickness and of less flexibility to be used.

By means of the invention, the pressure applied to each of the unit cells in order to guarantee satisfactory contact between the various elements comprising it can be controlled independently, without having an effect of a back pressure on the adjacent cell.

In FIG. 4, means to apply a compression effort symbolised by the arrow 18 to each of the unit cells of the battery of FIG. 1 can be seen represented schematically. For example, the compression on each of the cells is produced by a unit or tightening plates 20 positioned on the outer faces of the electrodes.

In a particularly advantageous manner, the assembly is placed in a sealed flexible packet consisting of a laminated assembly formed from at least one polyester or nylon outer polymer layer, a metal (aluminium) film intended to limit the micro-holes of the polymer film and a second polymer layer of the polyolefin type. This laminated assembly is commonly used as a flexible packet for batteries, thus ensuring gas-proofness, and allowing the thermo-sealing step. Due to the use of such sealed flexible packets, it is possible to pump down to a vacuum in the packet, which will guarantee the application of the sufficient pressure on the cell in order not to require an additional compression system. This pumping down to a vacuum enables the use of compression plates to be avoided.

In FIG. 5 a first example embodiment of the seals between cells and with respect to the outside environment can be seen for a battery having the configuration of FIG. 3.

In this first example embodiment each unit cell comprises, at its lateral edges, a gasket 22 to confine the electrolyte within the cells in separators S1, S2 and S3. In addition, this gasket 22 enables a short-circuiting of the electronic conductors to be prevented.

In the case of unit cells C1 and C3, gasket 22 extends between the current collector 6, 8 and the electronic conductor 110, 112 respectively over the entire circumference of cells C1 and C3.

In the case of unit cells C2, the joint 22 extends between the electronic conductor 110 and the electronic conductor 112, over the entire circumference of cell C2.

Joint 22 is, for example, an elastomer of the ethylene-propylene family such as EPDM, or of the butadiene styrene family such as latex, of the silicones family, or again of the thermoplastic rubbers family (TPE), of the styrenics type, such as SBS® or Kapton®.

The battery also has an electrical insulating film 24 covering all the unit cells connected in series. Only the battery's connection terminals traverse the jacket 24.

The film 24 can be of the adhesive film type, attached to the outer face of each of the electronic conductors. The presence of this film enables a short-circuiting of the cells with one another to be prevented, in particular in the case of folded configurations of the cells, as we shall see in due course.

In addition, it is advantageous to deposit specifically in the area of the connections between unit cells an additional electrical insulating layer 26, preferably an adhesive one. This layer 26 allows more robust sealing in the area of the connections which could be deformed, as we shall see in due course.

In FIG. 6 another example embodiment of the sealing and of the electrical insulation of the battery of FIG. 3 can be seen.

In this other example embodiment an injection technique is used. The joints 122 produced by plastic injection provide both the sealing of each cell and the compression on the electronic conductors.

The injected material may be an insulating thermoplastic polymer film (ethylene-propylene and ethylene norbornene block copolymers).

The battery assembly is then coated with an injected thermoplastic material or nano-material 28, for example of the PP, PEHD, COC, PMMA, PC PEEK or PPS type, which may contain fillers such as glass or carbon fibre, or nano-fillers such as carbon nanotubes, nanoclay, etc. To this end the electronic conductors have through channels in the connection area, like those described in relation to FIG. 2C.

The via holes 16 previously described in the electronic conductors 110, 112 allow the injected material to pass through. This example embodiment allows a battery to be produced with a fixed shape, and this coating protects it from outside impacts.

The via holes have, for example, a diameter of between 0.5 mm and 5 mm, and preferentially between 1 mm and 2 mm, and are 1 mm to 2 mm apart.

This example embodiment has the advantage that it requires no additional compression device, and gives the battery a definitive shape. As we shall see in due course, the present invention enables the battery to be shaped in a large number of configurations, and for these configurations to be fixed by the coating. The battery is given the desired shape, and during the coating this shape is fixed. It is conceivable to combine both example embodiments, for example by making a joint according to the first example and coating the battery by injection. A via hole zone must be provided to allow satisfactory injection of the polymer.

The present invention has great flexibility in terms of the connections between the unit cells. It is thus possible to orient the cells relative to one another with great freedom. The shape obtained in this manner is then fixed during the coating.

We shall now give an example embodiment of a bipolar electrode according to the present invention.

A positive electrode material of type LiFePO4 blended with a polymer binder of type PVDF is deposited on an aluminium conductor; the electrode material can be coated, painted, screen-printed or deposited in the form of spray.

A negative electrode material of type Li4Ti5O12 blended with a polymer binder of type PVDF is then deposited on the opposite face of the conductor in staggered fashion relative to the positive electrode; for example, the latter is coated, painted, screen-printed or deposited in the form of a spray.

Before depositing the electrodes masks may be used to define the electrode surfaces.

If no mask is used, there may be a step of removal of superfluous electrode materials by scraping of the superfluous electrode material.

The electrodes can also be produced by a deposit by slot die coating on both faces of the electronic conductor, which enables the bipolar electrode to be obtained directly with both electrode faces staggered relative to one another. The slot die method is a coating method allowing control in the direction orthogonal to the surface of the position of the head injecting the ink, which leads to the definition of deposit zones and zones free of deposit (the coating head is not in contact with the substrate in this step).

We shall now describe various examples of configurations which can be obtained by means of the present invention.

In FIGS. 7A and 7B the battery according to the present invention in the form of a winding can be seen. In FIG. 7A, the battery has four cells C1 to C4, each positioned at right angles relative to the adjacent cell.

In FIG. 7B, the battery has five unit cells C101 to C105 with different relative orientations.

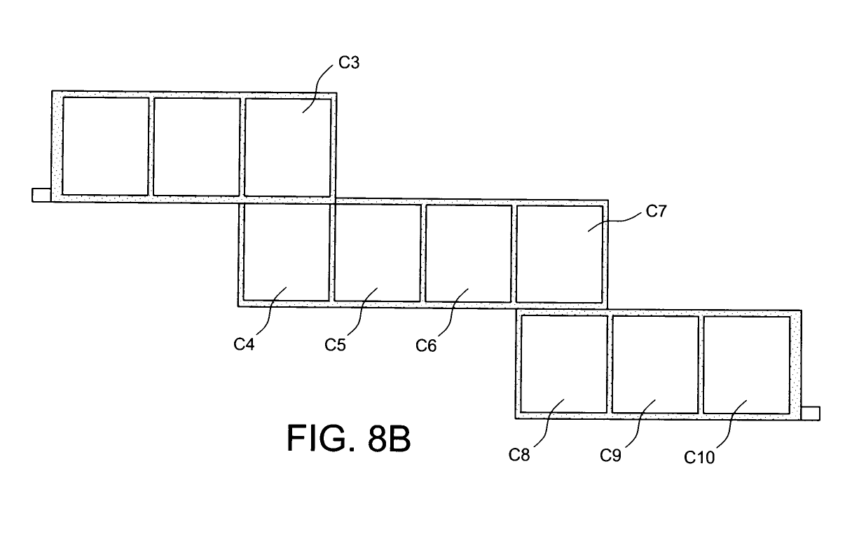

In FIG. 8A, a positioning of an assembly of unit cells forming cubes open on one face can be seen. The cubes are associated with one another by a bipolar cell according to the invention.

FIG. 8B shows the developed shape of the unit cells, the relative positioning of the conductors of which allows the structure of FIG. 8A to be produced in three dimensions. This battery has 10 unit cells, and it can be seen that cells C3 and C4 have an orientation different to that of cells C1 to C3. This different orientation is obtained by positioning the electronic conductor common to cells C3 and C4 orthogonally relative to the electronic conductor common to cells C2 and C3.

By virtue of the invention it is therefore possible to orient the electronic conductors so as to form geometrical shapes with ridges. The conductors are not thus necessarily aligned. Consequently, shapes in three dimensions can be produced. In addition, due to the coating or covering with an electrical insulating material, it is possible to ensure that a unit cell comes into contact with one or more other unit cells.

The production of such shapes enables batteries integration within tools or on small vehicles such as an electrically assisted bicycle to be facilitated, for example in a wheel hub-mounted motor, or inside a motor housing.

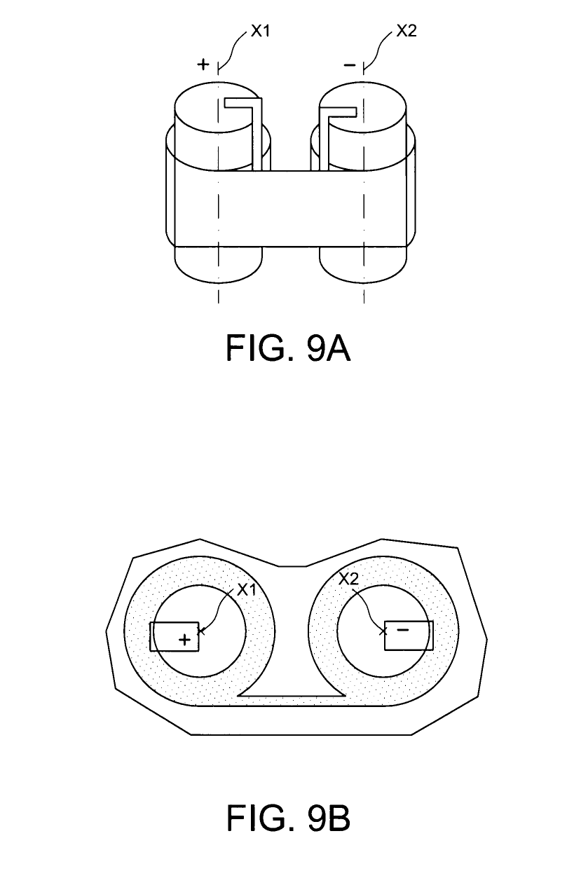

Furthermore, each unit cell has a certain flexibility, notably due to the fact that it uses only a single electrolytic cell; it is thus conceivable to produce a winding, as can be seen in FIGS. 9A and 9B. It is then possible to resemble the current shape of the batteries.

In FIGS. 9A and 9B two coiled cylinders coated in a plastic material can be seen.

Bipolar electrodes are produced as previously described. An assembly of unit cells is then produced so as to form a strip. The strip is then wound around two conductive spindles X1, X2 as represented in FIGS. 9A and 9B, by inserting an electrical insulating flexible film. This film is, for example, an electrical insulating flexible polymer such as PTFE, PVDF, silicone polyimide, polyurethane, parylene or PET. The potential difference at the terminals of the battery thus produced is that between the two conductive spindles. The shape of the assembly can be fixed by injection in a polymer described above.

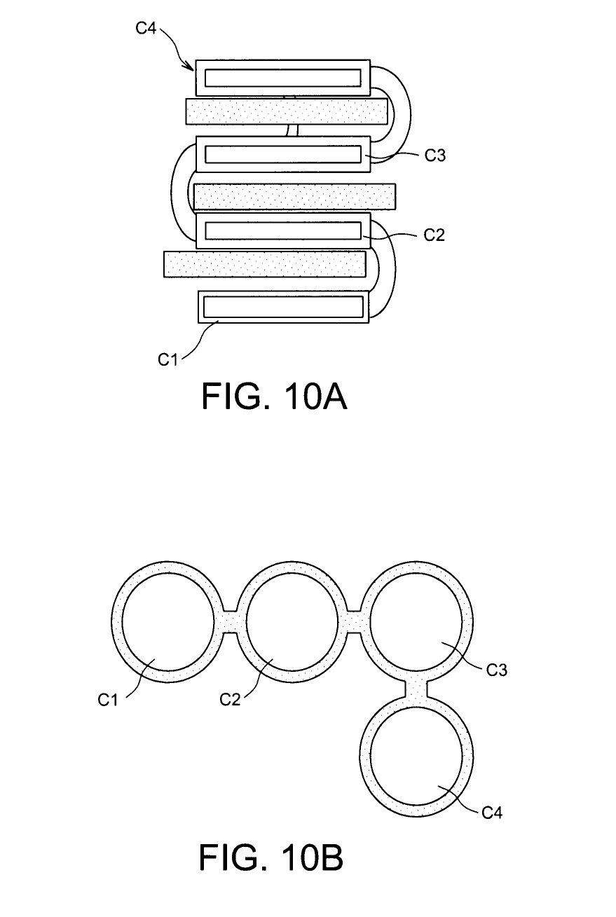

The flexibility between the unit cells can be sufficient to fold back the cells on to one another so as to form an accordion-like stack, as represented in FIG. 10A.

This configuration allows the production of stacked structures resembling the state of the art, whilst avoiding the problems of pressure and back pressure between the cells.

In FIG. 10B an example of the developed shape of the unit cells before folding can be seen.

It can be envisaged to fix the folded shape by injection, as described above. An insulating sheet 32 can then advantageously be used, such as, for example, an electrical insulating polymer such as PTFE, PVDF, silicone polyimide, polyurethane, parylene or PET) between each of the bipolar cells, in order to prevent short-circuiting of the cells on injection, and with a view to maintaining control of the inter-cell pressure.

In the representation of FIG. 10B the unit cells are disk-shaped; however, any other shape may be envisaged. It may be a polyhedron with n sides, where n is a positive integer.

In FIG. 10B, the cells are disk-shaped; consequently the electronic conductors are formed of two discs connected by a thinner connection area 34 forming a tab. In this case the dimensions of the tab are made sufficiently large to prevent local heating of the structure in the area of the connection when the current is applied.

It is also conceivable to connect sets of unit cells in series or in parallel, in order to produce batteries having a given current or a given voltage.

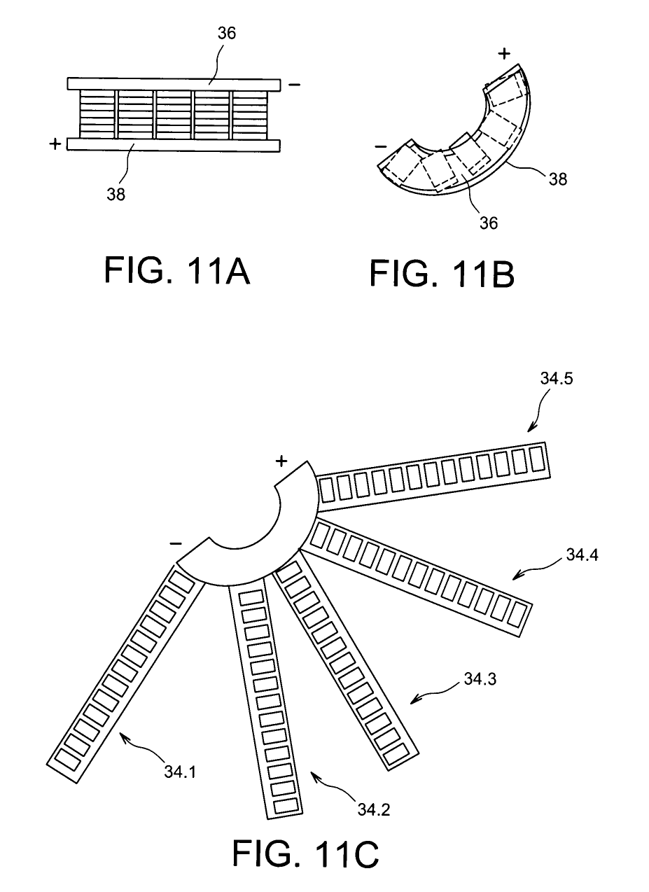

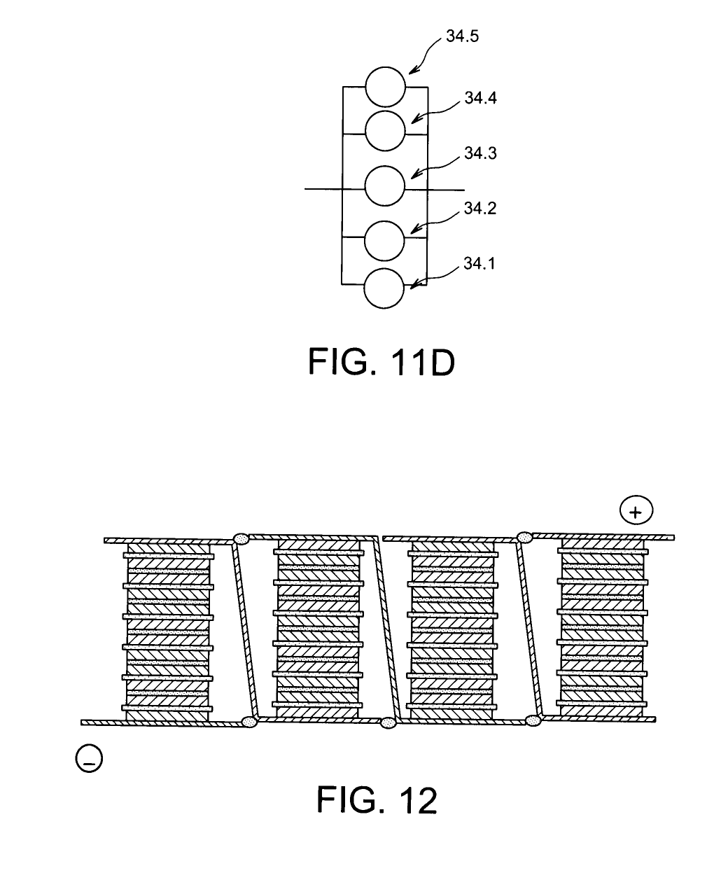

In FIGS. 11A and 11B an example embodiment of a battery consisting of five stacks 34.1, 34.2, 34.3, 34.4, 34.5 according to the present invention can be seen, connected in parallel by collectors 36, 38.

In FIG. 11C stacks 34.1 to 34.5 can be seen, as they are deployed before being given the shape of an accordion.

Stacks 34.1 to 34.5 are produced in a similar manner for the stack of FIG. 10A.

In FIG. 11D the electrical circuit of this battery is schematised.

In FIG. 12 another example embodiment of a battery according to the present invention comprising both stacks of the unipolar type can be seen, with insertion of a separator, as described in an architecture of document US2008/060189, connected in series by means of electronic conductors according to the present invention.

Insulating joints 42 are provided between each pair of adjacent electronic conductors 40.1 to 40.3.

We shall now give examples of batteries according to the present invention having given electrical characteristics.

In an example, it is desired to produce a battery set replacing a Ni-Cd 9.6 V, 2Ah battery of known type integrated in an electric drill.

For the production of the bipolar electrodes the method example described above is used, having as its pair of electrodes the LiFePO₄/Li₄Ti₅O₁₂ pair which produces a potential of 1.9 V.

To obtain a voltage of 9.6 V, each assembly has five unit cells, each providing a voltage of 1.9 V at its terminals. To accomplish this, four bipolar electrodes are produced, shared between the five unit cells, in which the ends of each stack are connected to unipolar collectors.

The five assemblies are connected in parallel, providing the desired current.

Each assembly can be positioned in a heat-sealable electrical insulating jacket pumped down to a vacuum in which only the positive and negative connections traverse the jacket, in order to provide the connection with the collectors connecting the five assemblies in parallel. Depending on the desired configuration, the cells may be oriented differently to one another, as may the assemblies.

In another example, it is desired to produce a battery providing at output a voltage of 24 V or 36V and allowing integration in a motor vehicle.

The LiFePO₄/Li4Ti₅O₁₂ electrode materials can be incorporated in bipolar assemblies, as is represented in FIG. 11C.

To meet a need for a nominal voltage of 24 V, assemblies of 13 unit cells in series are produced. The assemblies are then connected in parallel.

For a nominal voltage of 36 V, assemblies of 19 unit cells in series are produced. The assemblies are then connected in parallel.

The assemblies are then folded in an accordion shape, as described above.

In the example embodiments described above the positive electrode and the negative electrode of an element are positioned on two opposite faces. But it will be understood that they can be positioned on the same face, or on two oriented faces of the same side.

1-21. (canceled)

22. An element for a bipolar battery, intended for production of two unit cells comprising:
an electronic conductive support comprising a first electronic conductive support part, a second electronic conductive support part, an electronic conductive connection connecting the first and the second electronic conductive support parts, each electronic conductive support part comprising a first and second face distinct from first and second faces of another electronic conductive support part, the element also comprising a positive electrode material deposited on one of faces of the first electronic conductive support part and a negative electrode material deposited on one of faces of the other electronic conductive support part,
in which the first electronic conductive support part, the second electronic conductive support part, and the connection are produced as a single piece from a plate, the plate having a thickness of between 20 μm and 250 μm allowing easy shaping, and providing a certain flexibility, enabling the unit cells to be oriented relative to one another with great freedom.

23. An element for a bipolar battery according to claim 22, in which the faces, on which the positive electrode material and the negative electrode material are positioned, are opposite relative to a general surface formed by the support.

24. An element for a bipolar battery according to claim 22, in which the first electronic conductive support and the second electronic conductive support are positioned in two parallel planes.

25. An element for a bipolar battery according to claim 22, in which the first electronic conductive support and the second electronic conductive support are made from nickel, copper, aluminium, or aluminium alloy.

26. An element for a bipolar battery according to claims 22, formed by a sealed carbon fabric on which a metal film, or a film of nickel, copper or aluminium, is deposited on one of faces of the fabric.

27. An element for a bipolar battery according to claim 22, in which the positive electrode material is LiFePO4 blended with a polymer binder of type PVDF and the negative electrode material is Li4Ti5O12 blended with a polymer binder of type PVDF.

28. A bipolar battery comprising at least one element according to claim 22, in which the positive electrode material supported by the first electronic conductive support is positioned facing a negative electrode material, the negative electrode material supported by the second electronic conductive support is positioned facing a positive electrode material, the facing electrode materials being separated by an insulator containing an electrolyte, thus forming two juxtaposed unit cells.

29. A bipolar battery according to claim 28, in which an electrical insulated joint is interposed between the facing elements so as to seal the unit cells, and an electrically insulating film covers free faces of the supports; the insulated joint is made from elastomer, latex, or thermoplastic rubber.

30. A bipolar battery according to the claim 29, comprising an additional film thickness in an area of the electronic connections between the support of a given element.

31. A bipolar battery according to claim 30, comprising means for applying a compression effort to each unit cell to apply, one against the other, the positive electrode materials, the negative electrode materials, and the insulator of each unit cell.

32. A bipolar battery according to claim 29, comprising an airtight jacket in which the unit cells are introduced, the jacket being pumped down to a vacuum, such that compression efforts are applied to the unit cells.

33. A bipolar battery according to claim 29, in which sealing of the unit cells is obtained by injection of a joint, or made of thermoplastic polymer, and the cells are compressed by coating with a thermoplastic material, or made by injection.

34. A bipolar battery according to claim 30, in which the elements have through channels, of via hole type, in the area of the connection between the supports.

35. A bipolar battery according to claim 28, in which the unit cells are positioned in a rectilinear strip.

36. A bipolar battery according to claim 35, in which a part of the strip is wound around a conductive spindle and another part of the strip is wound around another conductive spindle, with an electrical insulating film being inserted in the windings, and with a voltage at terminals of the battery being a voltage between the two conductive spindles.

37. A bipolar battery according to claim 35, in which two adjacent unit cells are folded back one towards the other so as to be stacked, with an electrically insulating film being positioned between the adjacent unit cells.

38. A bipolar battery according to claim 28, in which adjacent unit cells are oriented in different directions.

39. A bipolar battery according to claim 38, in which the unit cells are oriented so as to form a structure in three dimensions.

40. A bipolar battery according to claim 28, comprising, connected in parallel, at least two assemblies of unit cells connected in series.

41. A bipolar battery, comprising at least a first element and a second element according to claim 22, the positive electrode material of the first element being positioned facing a negative electrode material of the second element, the negative electrode material of the first element being positioned facing a positive electrode material, and the positive electrode material of the second element being positioned facing a negative electrode material, and an insulator containing an electrolyte being positioned between the pairs of facing electrode materials, so as to form three juxtaposed unit cells.

42. A bipolar battery according to claim 41, in which an electrical insulated joint is interposed between the facing elements so as to seal the unit cells, and an electrically insulating film covers free faces of the supports; and the insulated joint is made from elastomer, latex or thermoplastic rubber.

43. A bipolar battery according to claim 42, comprising an additional film thickness in the area of the electronic connections between the support of a given element.

44. A bipolar battery according to the claim 43, comprising means for applying a compression effort to each unit cell to apply, one against the other, the positive electrode materials, the negative electrode materials, and the insulator of each unit cell.

45. A bipolar battery according to the claim 42, comprising an airtight jacket in which the unit cells are introduced, the jacket being pumped down to a vacuum, such that compression efforts are applied to the unit cells.

46. A bipolar battery according to claim 41, in which sealing of the unit cells is obtained by injection of a joint, or made of thermoplastic polymer, and the cells are compressed by coating with a thermoplastic material, or by injection.

47. A bipolar battery according to claim 46, in which the elements have through channels, of the via hole type, in the area of the connection between the supports.

48. A bipolar battery according to claim 41, in which the unit cells are positioned in a rectilinear strip.

49. A bipolar battery according to claim 48, in which a part of the strip is wound around a conductive spindle and another part of the strip is wound around another conductive spindle, with an electrical insulating film being inserted in the windings, and with a voltage at terminals of the battery being a voltage between the two conductive spindles.

50. A bipolar battery according to claim 48, in which two adjacent unit cells are folded back one towards the other so as to be stacked, with an electrically insulating film being positioned between the adjacent unit cells.

51. A bipolar battery according to claim 41, in which adjacent unit cells are oriented in different directions.

52. A bipolar battery according to claim 51, in which the unit cells are oriented so as to form a structure in three dimensions.

53. A bipolar battery according to claim 40, comprising, connected in parallel, at least two assemblies of unit cells connected in series.
